(19) United States
(12) Patent Application Publication
(10) Pub. No.: US 2015/0222177 A1
(43) Pub. Date: Aug. 6, 2015

(54) High efficient single stage half bridge power factor correction converter

(71) Applicant: Fuxiang Lin, Lidcombe (AU)

(72) Inventor: Fuxiang Lin, Lidcombe (AU)

(21) Appl. No.: 14/170,654

(22) Filed: Feb. 3, 2014

(51) Int. Cl. H02M 1/42; H02M 5/45

(52) U.S. Cl. CPC H02M 1/4208; H02M 5/4505; H02M 2001/0067

(57) ABSTRACT

A half-bridge single stage PFC power converter includes a forward transformer and a main transformer. The primary windings of two transformer are connected in series. The main transformer transmits energy from a primary circuit to a secondary circuit. The forward transformer transits energy to PFC windings of the forward transformer to correct an input current waveform. A capacitor is connected to the primary winding of the forward transformer to reduce the switching loss of the converter.

### BACKGROUND OF THE INVENTION

1. Field of the Invention

The present invention relates to a power converter, and more particularly, to a power factor correction(PFC) half bridge converter in single stage.

2. Description of the Related Art

Power converters have widely served to convert an unregulated power source to regulated voltage or current.

A PFC (Power Factor Correction) technique is applied to make an input current follow the waveform of an input voltage. Adding a PFC stage to the front end of a power converter substantially avoids unnecessary power loss and heat dissipation in a power contribution system.

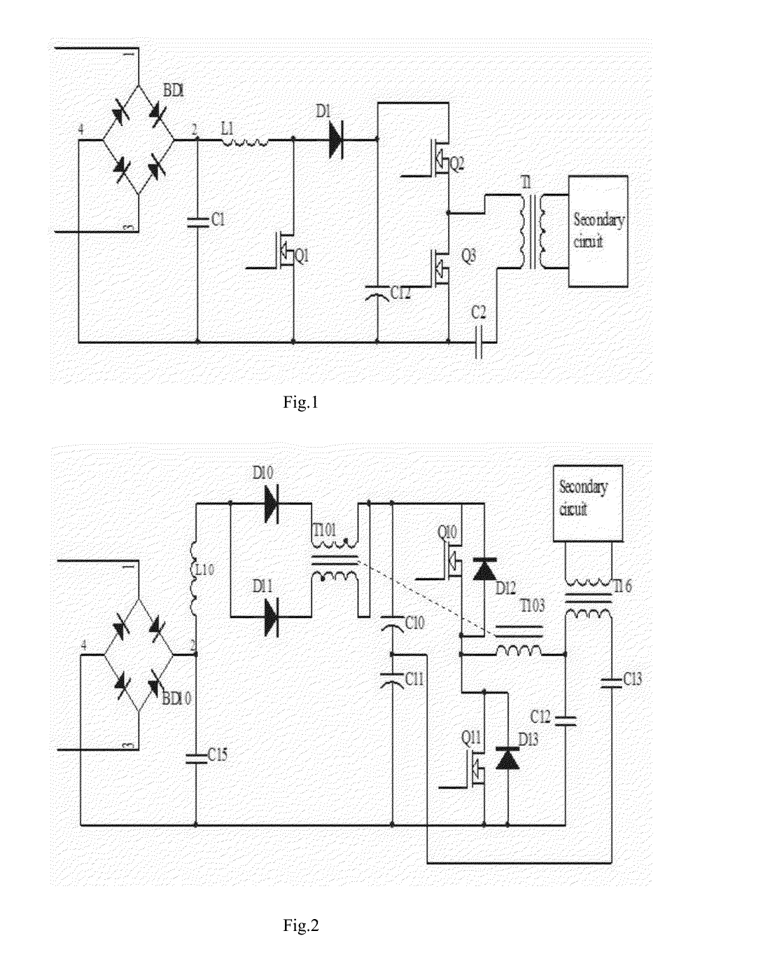

Referring to FIG. 1, a power converter having two stages according to prior art is illustrated. A first stage is A PFC stage, Which includes an inductor L1, a rectifier BD1 and a transistor Q1. The transistor is driven by a control signal PFC from the PFC stage. A second stage includes two transistors Q2, Q3 controlled by a control signal PWM, a transformer T1 and a secondary circuitry, thus output voltage is regulated and output ripple noise is reduced. However, the PFC stage configuration increases the cost and device counts of the power converter, hence efficiency of the power converter is reduced. Therefore, the development trend of power converters is to build a single stage power converter with PFC function. The present invention provides a single stage PFC half bridge power converter to reduce the cost and the size, i.e. device counts, and to improve efficiency of the power converter. The present invention provides a power converter operating in lower stress to obtain high reliability.

### SUMMARY OF THE INVENTION

The present invention provides a single stage power factor correction (PFC) power converter that performs a PFC function to a half-bridge. The single stage PFC half-bridge includes a power factor correction transformer which is consists of a primary winding and a power factor correction winding, a main transformer which is consist of the primary winding and a secondary winding. The primary winding of power factor correction transformer is connected in series with the primary winding of the main transformer. A part of the energy of the series circuit is used to correct the power factor of the converter and most of the energy of the series circuit is transferred to the secondary circuit of the converter. A capacitor is connected between junction of the two primary windings and the first end of upper switch or the second terminal of the lower switch.

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a schematic diagram illustrating a power converter according to a prior art.

FIG. 2 is a schematic diagram illustrating a single stage half-bridge PFC power converter according one embodiment of the present invention.

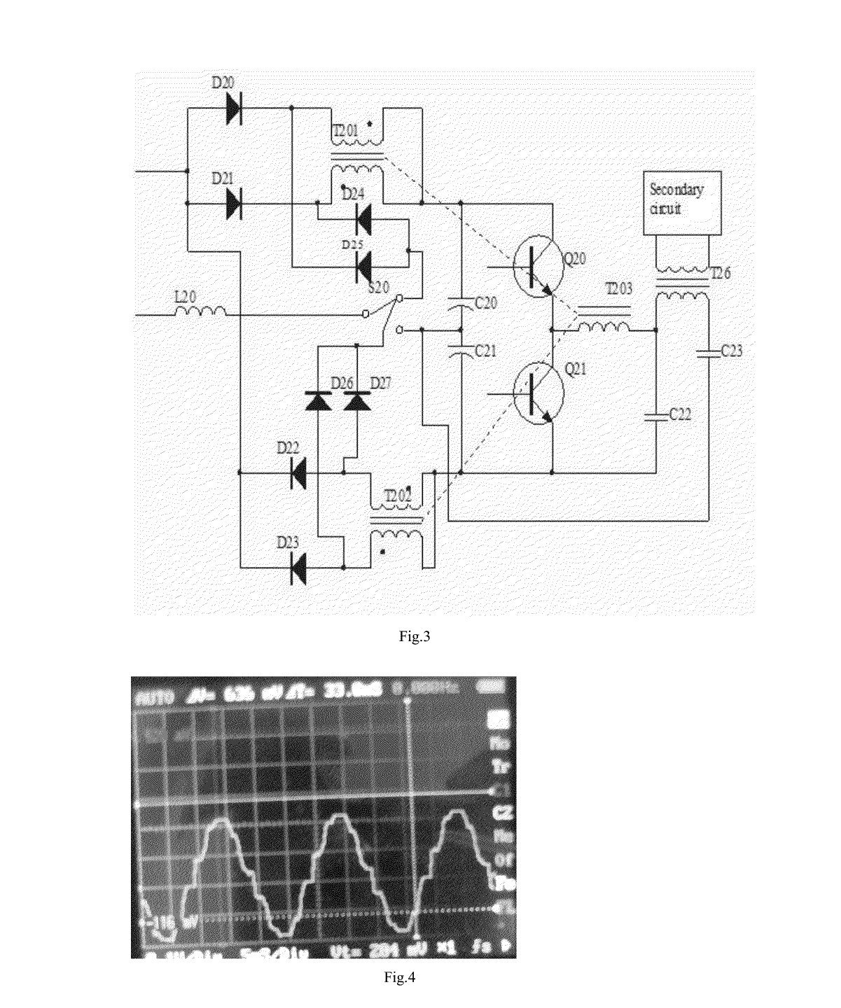

FIG. 3 is a schematic diagram illustrating a 120 v or 240 v single stage half-bridge PFC power converter according one embodiment of the present invention.

FIG. 4 is an input current waveform of a 250 w a prototype.

### DESCRIPTION OF THE EMBODIMENTS

Before explaining the disclosed embodiment of the present invention in detail, it is to be understood that the invention is not limited in its application to the details of the particular arrangement shown since the invention is capable of other embodiments. The topology of the present invention is that a primary winding of a power factor correction transformer is connected in series with the main transformer, which transfers power from the primary circuit to the secondary circuit, and power factor correction windings of the forward transformer are used to correct the input current waveform.

Referring to FIG. 2, a half-bridge single stage power factor correction power converter according to an embodiment of the present invention is illustrated.

The half-bridge single stage PFC converter consist of:

A bridge rectifier BD10 has two input terminals which are coupled to two input AC power lines, a positive output terminal and a negative output terminal.

A first capacitor C15 is between the two output terminals of the bridge rectifier.

A forward transformer has a primary winding T103 which has a first terminal and a second terminal and a PFC winding T101 which has a first terminal, a second terminal and a center-tap.

An inductor L10 has a first terminal which is coupled to the positive output of the rectifier BD10 and a second terminal.

A first diode D10 has an anode which is connected to the second terminal of the inductor L10 and a cathode which is coupled to the first terminal of the PFC winding T101 of the forward transformer.

A second diode D11 has an anode which is connected to the second terminal of the inductor L10 and a cathode which is coupled to the second terminal of the PFC winding T101 of the forward transformer.

A second capacitor C10 has a positive terminal which is coupled to the center-tap of the PFC winding T101 of the forward transformer and a negative terminal.

A third capacitor C11 has a positive terminal which is coupled to the negative terminal of the second capacitor C10 and a negative terminal which is coupled to the negative output terminal of the rectifier BD10.

A upper switch Q10 has a first terminal which is coupled to the positive terminal of the second capacitor C10, a second terminal which is coupled to the first terminal of the primary winding T103 of the forward transformer and a control terminal which is controlled by a signal of PWM or PFM.

Lower switch Q11 has a first terminal which is coupled to the second terminal of the upper switch Q10, a second terminal which is coupled to the negative terminal of the third capacitor C11, control terminal which is controlled by a control signal PWM or PFM.

A main transformer T16 has a secondary terminal which is coupled to a secondary circuitry and a primary winding which has a first terminal connected to the second terminal of the primary winding T103 of the forward transformer and a second terminal.

The fourth capacitor C12 has a first terminal which is coupled to the second terminal of the primary winding T103 of the forward transformer and a second terminal which is coupled to the second terminal of the lower switch Q11 or the first terminal of the upper switch Q10.

A fifth capacitor C13 has a first terminal which is coupled to the second terminal of the primary winding of the main transformer T16 and a second terminal which is coupled to the negative terminal of the second capacitor C10.

The operation of the FIG. 2 is following:

When the upper switch Q10 is switch on, a current flows through path consisting of the upper switch Q10, the primary winding T103 of the forward transformer and the fourth capacitor C12, a current discharged from second capacitor C10 flows through the path consisting of the first switch Q10, the primary winding T103 of the forward transformer, the primary winding of the forward transformer T16 and the fifth capacitor C13. At the same time, there is an induced voltage in the PFC winding T101 of the forward transformer. The input voltage with this induced voltage in the PFC winding T101 of the forward transformer forces a current flow through through path consisting of the inductor L10, the first diode D10 and the PFC winding T101 of the forward transformer to charge the second capacitor C10 and the third capacitor C11. When the upper switch Q10 is switched off, there is an induced voltage in the inductor L10 and this induced voltage with the input voltage force a current through the path consisting of inductor L10, the second diode D11, the PFC winding T101 of the forward transformer to charge the second capacitor C10 and third capacitor C11. At same time, the voltage in the fifth capacitor provides the zero voltage switching condition for the upper switch.

When the lower switch Q11 is switched on, a current discharged from the third capacitor C11 conducts through path consisting of the fifth capacitor C13, the primary winding of the main transformer T16, the primary winding T103 of the forward transformer and the lower switch Q11 to the negative terminal of the third capacitor C11, a current discharging from the fourth capacitor C12 conducts through the path consisting the primary winding T103 of the forward transformer and the lower switch Q11. At the same time, there is induced voltages in PFC winding T101, This induced voltage with the input voltage forces a current flow through path consisting of the inductor L10, the second diode D11, the PFC winding T101 to charge the second capacitor C10 and the third capacitor C11. When the lower switch Q11 is switched off, there is an induced voltage in the inductor L10 and the input voltage with this induced voltage forces a current flow through path consisting of the inductor L10, the first diode D10, the PFC winding T101 charging the second and the third capacitor C10, and C11. The zero voltage across the fourth capacitor C12 provides a zero voltage switching condition for the lower switch switching. The ratio of a number winding of the PFC windings T101 and a number of the primary winding T103 of the forward transformer is 1:1.5-3. The inductor is chosen according to the maximum power range of the power converter and the number of the primary winding T103 of the forward transformer. The more windings of the primary winding T103, the less value of the inductor L10 is selected to keep the primary voltage across the second and the third capacitor C10, C11 around peak value of the input voltage.

Referring to FIG. 3, a 120 and 240 single stage half-bridge power factor correction power converter according to an embodiment of the present invention is illustrated.

The 120&240V single stage half bridge power factor correction power converter consist of:

A forward transformer has a first PFC winding T201 which has a first terminal, a second terminal and a center-tap, a second PFC winding T202 which has a first terminal, a second terminal and a center-tap and a primary winding T203 which has a first terminal and a second terminal.

A first diode D20 has a cathode which is coupled to a first terminal of the first PFC winding T201 of the forward transformer and an anode which is coupled to a first power line.

A second diode D21 has a cathode which is coupled to a second terminal of the first PFC winding T201 of the forward transformer and an anode which is coupled to a first power line.

A third diode D22 has a cathode which is coupled the first input power line and an anode which is coupled to the first terminal of the second PFC winding T202 of the forward transformer.

A fourth diode D23 has cathode which is coupled to the first input power line and an anode which is coupled to the second terminal of the second PFC winding T202 of the forward transformer.

A first capacitor C20 has a positive terminal which is coupled to the center-tap of the first PFC winding T201 and a negative terminal.

A second capacitor C21 has a positive terminal which is coupled to the negative terminal of the first capacitor C20 and a negative terminal which is coupled to the center-tap of the second PFC winding T202.

A fifth diode D24 has an anode and a cathode which is coupled to the second terminal of the first PFC winding T201.

A sixth diode D25 has a cathode which is coupled to the first terminal of the first PFC winding T201 and an anode which is coupled to the anodes of the fifth diode D24.

A seventh diode D26 has a cathode which is coupled to the anode of the sixth diode D25 and an anode which is coupled to the second terminal of the second PFC winding T202.

An eighth diode D27 has an anode which is coupled to the first terminal of the second PFC winding T202 and a cathode which is coupled to the anode of the fifth diode D24.

An inductor L20 has a first terminal which is coupled to a second input AC power line and a second terminal. This inductor also can be connected between the anode of the first diode D20 and the first input AC power line.

A switch S20 has a first terminal which is coupled to the second terminal of the inductor L20, a second terminal which is coupled to the anode of the fifth diode D24 and a third terminal which is coupled to the negative terminal of the first capacitor C20.

A upper transistor switch Q20 has a first terminal which is coupled to the positive terminal of the first capacitor C20, a second terminal which is coupled to the first terminal of the primary winding T203 of the forward transformer and a control terminal which is controlled by a control signal PWM or PFM.

A lower transistor switch Q21 has a first terminal which is coupled to the second terminal of the upper transistor switch Q20, a second terminal which is coupled to the negative terminal of the second capacitor C21 and a control terminal which is controlled by a control signal PWM or PFM.

A main transformer T16 has a secondary winding which is coupled to a secondary circuitry and a primary winding which has a first terminal coupled to the second terminal of the primary winding T203 and a second terminal.

A third capacitor C22 has a first terminal which is coupled to the second terminal of the primary winding T203 of the forward transformer and a second terminal which is coupled to the second terminal of the lower transistor switch Q21 or the first terminal of the upper transistor switch Q20.

A fourth capacitor C23 has a first terminal which is coupled to the second terminal of the primary winding of the main transformer T16 and a second terminal which is coupled to the third terminal of the switch S20.

The operation of the FIG. 3 is following:

When there is 120 v AC input, the first and third terminals of the switch S20 are connected. When upper transistor switch Q20 is on, a current discharged from the first capacitor C20 flows through the path consist of upper transistor switch Q20, the primary winding T203 of the forward transformer, the primary winding of the main transformer T26 and the fourth capacitor C23 and a current discharged from the first capacitor C20 and the second capacitor C21 flows through the path consist of the upper transistor switch Q20, the primary winding T203 of the forward transformer and the third capacitor C22. At the same time, there is an induced voltage in the PFC windings T201, T202 of the forward transformer and the input voltage with this induced voltage forces a current flow through a path consisting of the first diode D20, the first PFC winding T201 of the forward transformer, the first capacitor C20, the switch S20 and the inductor L20 to charge the first capacitor C20 if the voltage of the first AC power line is higher than that of the second input AC power line or flow through a path consisting of the fourth diode D23, the second PFC winding T202 of the forward transformer, the second capacitor C21, the switch S20 and the inductor L20, if the voltage of the first input AC power line is lower than that of the second input AC power line.

When the upper transistor switch Q20 is off, there is an induced voltage in the inductor, the input voltage with this induced voltage forces a current flow through the path consisting of the second diode D21, the first PFC winding T201 of the forward transformer, the first capacitor, the switch S20 and the inductor L20 to charge the first capacitor C20 to charge the first capacitor C20, if the voltage of the first AC power line is higher than that of the second input AC power line or through a path consisting of the third diode D22, the second PFC winding T202, the second capacitor C21, the switch S20 and the inductor L20 to charge the second capacitor C21, if the voltage of the first input AC power line is lower than that of the second input AC power line.

When the lower transistor switch Q21 is on, a current discharged from the second capacitor C21 conducts through a path consisting of the fourth capacitor C23, the primary winding of the main transformer T26, the primary winding T203 of the forward transformer, the lower transistor switch Q21 and a current discharged from the third capacitor C22 conducts through a path consisting of the primary winding T203 of the forward transformer and the lower transistor switch Q21.

At the same time, there is an induced voltage in the PFC windings of the forward transformer, the input voltage with this induced voltage forces a current flows through the path consisting of the second diode D21, the first PFC winding T201, the first capacitor C20, the switch S20 and the inductor L20 to charge the first capacitor C20 if the voltage of the first AC power line is higher than that of the second input AC power line or through a path consisting of the third diode D22, the the second PFC winding T202 of the forward transformer, the second capacitor C21, the switch S20 and the inductor to charge the second capacitor C21 if the voltage of the first input AC power line is lower than that of the second input AC power line.

When the lower transistor switch Q21 is off, there is an induced voltage in the inductor L20, the input voltage with this induced voltage forces a current flow through a path consisting of the PFC winding T201 of the first diode D20, the forward transformer, the first capacitor, the switch S20 and the inductor L20 to charge the first capacitor C20 if the voltage of the first AC power line is higher than that of the second input AC power line or through a path consisting of the fourth diode D23, the second PFC winding T202, the second capacitor C21, the switch S20 and the inductor L20 to the second capacitor C21, if the voltage of the first input AC power line is lower than that of the second input AC power line.

A voltage in the third capacitor provide a zero voltage switching condition for both of the upper transistor switch Q20 and the lower transistor switch Q21.

When the input voltage is 240 v, the first and the second terminals of the switch are connected.

The operation principle is similar to 120 v operation except when the voltage of the first AC power line is higher than that of the second input AC power line, a current charging the first and second capacitor C20, C21 through a path consisting of the first diode D20, the seventh diode D26, both of the first and the second PFC windings, the switch S20 and the inductor or through the second diode D21, the eighth diode D27, both of the PFC windings, the switch S20 and the inductor.

when the voltage of the first AC power line is lower than that of the second input AC power line, a current charging the first and second capacitor C20, C21 through a path consisting of the third diode D22, the fifth diode D24 and both of the PFC windings, the switch S20 and the inductor L20 or through a path consisting of the fourth diode D23, the sixth diode D25, both of the PFC windings, the switch S20 and the inductor L20.

What is claimed is:

1. A single stage half-bridge PFC power converter, comprising:
A bridge rectifier has two input terminals which are coupled to two input AC power lines, positive output terminal and negative output terminal;
A first capacitor is coupled between the two output terminals;
An inductor has a first terminal which is connected to the positive output of the bridge rectifier and a second terminal;
A first diode has an anode which is connected to the second terminal of the inductor and a cathode;
A second diode has an anode which is connected to the second terminal of the inductor and a cathode;
A forward transformer has a primary winding and a PFC winding; the PFC winding has a center-tap; a first terminal of said first PFC winding is coupled to the cathode of the first diode and a second terminal of said second PFC winding is coupled to the cathode of the second diode;
A first capacitor is coupled between the output of said bridge-rectifier;
A second capacitor has a positive terminal which is coupled to the center-tap of the PFC winding of the forward transformer and a negative terminal;
A third capacitor has a positive terminal which is coupled to a negative terminal of the second capacitor and a negative terminal which is coupled to a negative output terminal of bridge-rectifier;
A upper switch has a first terminal which is coupled to the positive terminal of second capacitor, a second terminal which is coupled to the first terminal of primary winding of the forward transformer and a control terminal which is coupled to control signal of PWM;
A lower switch has a first terminal which is coupled to the second terminal of the first switch and a second terminal which is coupled to the negative output terminal of said bridge-rectifier and a control terminal which is coupled to control signal of PWM;
A main transformer has a primary winding and a secondary winding which is coupled to a secondary circuitry; a first terminal of said primary winding is coupled to the second terminal of primary winding of the forward transformer;
A fourth capacitor has a first terminal is coupled to a second terminal of said primary winding of said forward transformer and a second terminal is coupled to the second terminal of the lower switch;
A fifth capacitor has a first terminal which is coupled to the second terminal of the primary winding of the main transformer and the second terminal which is coupled to the negative terminal of the second capacitor and the positive terminal of the third capacitor.

2. The single stage half-bridge PFC power converter in claim 1, wherein the primary winding of said main transformer, the primary winding of said forward transformer, and the fourth capacitor are coupled in series, and energy in primary winding of said forward transformer is transferred to the PFC windings of said forward transformer to correct the input current waveform.

3. The single stage half-bridge PFC power converter in claim 1, wherein the inductor, the first diode or the second diode and PFC winding of said forward transformer are coupled in series to form a path to be used to charge the second capacitor and the third capacitor.

4. The single stage half-bridge PFC power converter in claim 1, wherein the fourth capacitor and the primary winding of the forward transformer is connected in series and this circuit acts as no loss snubber to reduce switching losses of the upper switch and the lower switch.

5. The single stage half-bridge PFC power converter in claim 3, wherein said the inductor is used to smooth the input current and to store electrical energy when the upper switch or the lower switch is on and to release the energy when the upper switch or the lower switch is off.

6. The single stage half-bridge PFC power converter in claim 3, wherein said the series connection of the inductor, the first diode, the second diode, the PFC winding of the forward transformer, the second and the third capacitor has several different arrangements and the function of these arrangements are the same.

7. The 120&240V single stage half bridge power factor correction power converter consist of:
A forward transformer has a first PFC winding which has a first terminal, a second terminal and a center-tap, a second PFC winding which has a first terminal, a second terminal and a center-tap and a primary winding which has a first terminal and a second terminal.
A first diode has a cathode which is coupled to a first terminal of the first PFC winding of the forward transformer and an anode which is coupled to a first power line.
A second diode has a cathode which is coupled to a second terminal of the first PFC winding of the forward transformer and an anode which is coupled to a first power line.
A third diode has a cathode which is coupled the first input power line and an anode which is coupled to the first terminal of the second PFC winding of the forward transformer.
A fourth diode has cathode which is coupled to the first input power line and a cathode which is coupled to the second terminal of the second PFC winding of the forward transformer.
A first capacitor has a positive terminal which is coupled to the center-tap of the first PFC winding and a negative terminal.
A second capacitor has a positive terminal which is coupled to the negative terminal of the first capacitor and a negative terminal which is coupled to the center-tap of the second PFC winding.
A fifth diode has an anode and a cathode which is coupled to the second terminal of the first PFC winding.
A sixth diode has a cathode which is coupled to the second terminal of the first PFC winding and an anode which is coupled to the anodes of the fifth diode.
A seventh diode has a cathode which is coupled to the anode of the sixth diode and an anode which is coupled to the second terminal of the second PFC winding.
An eighth diode has an anode which is coupled to the first terminal of the second PFC winding and a cathode which is coupled to the anode of the five diode.
An inductor has a first terminal which is coupled to a second input AC power line and a second terminal. This inductor also can be connected between the anode of the first diode and the first input AC power line.
A switch has a first terminal which is coupled to the second terminal of the inductor, a second terminal which is coupled to the anode of the fifth diode and a third terminal which is coupled to the negative terminal of the first capacitor.
A upper transistor switch has a first terminal which is coupled to the positive terminal of the first capacitor, a second terminal which is coupled to the first terminal of the primary winding of the forward transformer and a control terminal which is controlled by a control signal PWM or PFM.
A lower transistor switch has a first terminal which is coupled to the second terminal of the upper transistor switch, a second terminal which is coupled to the negative terminal of the second capacitor and a control terminal which is controlled by a control signal PWM or PFM.
A main transformer has a secondary winding which is coupled to a secondary circuitry and a primary winding which has a first terminal coupled to the second terminal of the primary winding and a second terminal.
A third capacitor has a first terminal which is coupled to the second terminal of the primary winding of the forward transformer and a second terminal which is coupled to the second terminal of the lower transistor switch or the first terminal of the upper transistor switch.
A fourth capacitor has a first terminal which is coupled to the second terminal of the primary winding of the main transformer and a second terminal which is coupled to the third terminal of the switch.

8. A 120 &240 V single stage half-bridge PFC power converter in claim 7, wherein said the primary winding of the forward transformer and primary winding of the main transformer is connected in series, the power through primary winding of the forward transformer is transferred to the PFC winding to correct the input current waveform and the energy through primary winding of the main transformer is transferred to the secondary circuit.

9. A 120 &240 V single stage single switch PFC power converter in claim 7, wherein said the switch is used to switch position to adapt to AC input voltage.

10. A 120 &240 V single stage half-bridge PFC power converter in claim 7, wherein said the inductor is used to smooth the input current to improve input current waveform; said the inductor stores energy when a transistor switch is on and release its energy when a transistor switch is off, the inductor has two connecting position said connecting between the second input AC power line and the first terminal of the switch or said connecting between the first input AC power line and the anode of the first diode.

11. A 120 &240 V single stage half-bridge PFC power converter in claim 7, wherein said when the switch position is in second terminal, the PFC windings is used in a path said consisting of the first or the second diode, the first PFC winding, the first capacitor, the second capacitor, the second PFC winding, the seventh diode, the eighth diode, the switch and the inductor, or a path said consisting of inductor, the switch, the fifth diode, the sixth diode, the first PFC winding, the first capacitor, the second capacitor, the third or the fourth diode and the second PFC winding to charge the storage capacitor said the first and the second capacitor, when a transistor switch is on.

12. A 120 &240 V single stage half-bridge PFC power converter in claim 7, wherein said when the switch position is in third terminal, the PFC winding is used in path said consisting of the first diode, the second diode, the first PFC winding, the first capacitor, the switch and inductor or in the path said consisting of the third diode, the fourth diode, the second PFC winding, the second capacitor, the switch and the inductor to charge the storage capacitors said the first capacitor or the second capacitor, when the transistor switch is on.
